(19) United States
(12) Patent Application Publication
(10) Pub. No.: US 2026/0179204 A1
(43) Pub. Date: Jun. 25, 2026

(54) METHOD OF ACQUIRING IMAGE, APPARATUS OF ACQUIRING IMAGE, AND METHOD OF DETECTING DEFECT

(71) Applicant: BOE Technology Group Co., Ltd., Beijing (CN)

(72) Inventors: Hao TANG, Beijing (CN); Hongxiang SHEN, Beijing (CN); Ronghua LAN, Beijing (CN); Jiuyang CHENG, Beijing (CN); Ting WANG, Beijing (CN); Qing ZHANG, Beijing (CN); Zhidong WANG, Beijing (CN); Quanguo ZHOU, Beijing (CN); Junrui ZHANG, Beijing (CN); Xuehui ZHU, Beijing (CN); Yancheng LU, Beijing (CN); Xiuru SUN, Beijing (CN); Meng GUO, Beijing (CN)

(21) Appl. No.: 18/713,170

(22) PCT Filed: Mar. 3, 2023
(86) PCT No.: PCT/CN2023/079447

§ 371 Date: May 23, 2024

(51) Int. Cl. G06T 7/00; G06T 7/11; G06T 7/70; G06T 7/73; G06T 7/90

(52) U.S. Cl. CPC G06T 7/0004; G06T 7/0012; G06T 7/11; G06T 7/70; G06T 7/74; G06T 7/90

(57) ABSTRACT

A method of acquiring an image, an apparatus of acquiring an image and a method of detecting a defect are provided, which relate to a field of image acquisition and processing. The method includes: capturing an image of a target object with lighting of a shadowless light source, where the image contains first and second regions of the target object which have different surface heights from each other; calculating N feature values of the image according to a relative positional relationship between the first and second regions; determining a displacement correction value of the shadowless light source according to the N feature values, in response to the N feature values not meeting a predetermined condition; and adjusting a position of the shadowless light source according to the displacement correction value to re-capture the image and re-calculate the N feature values until the N feature values meet the predetermined condition.

### CROSS-REFERENCE TO RELATED APPLICATION(S)

This application is a Section 371 National Stage Application of International Application No. PCT/CN2023/079447, filed on Mar. 3, 2023, entitled “METHOD OF ACQUIRING IMAGE, APPARATUS OF ACQUIRING IMAGE, AND METHOD OF DETECTING DEFECT”, which is incorporated herein by reference in its entirety.

### TECHNICAL FIELD

The present disclosure relates to a field of image acquisition and processing, in particular to a method of acquiring an image, an apparatus of acquiring an image, and a method of detecting a defect.

### BACKGROUND

An image processing technology is widely used in various scenarios, such as target classification, defect detection, target recognition, and machine vision. Before image processing, an image acquisition may be performed on a target object, for example, by capturing an image of the target object using a camera, to obtain an image that meets requirements. The image acquisition may be easily affected by a surface shape of the target object and an external light source. When at least two regions on the target object have different surface heights, it is difficult to balance image acquisition qualities of all regions, and the acquired image may have shadows, blurring, or uneven brightness, which is not conducive to subsequent image processing.

The above information disclosed in this section is just for understanding of the background of the inventive concept of the present disclosure. Therefore, the above information may contain information that does not constitute a related art.

### SUMMARY

Embodiments of the present disclosure provide a method of acquiring an image, an apparatus of acquiring an image, and a method of detecting a defect.

In an aspect, a method of acquiring an image is provided, including: capturing an image of a target object with lighting of a shadowless light source, where the image contains a first region of the target object and a second region of the target object, and a surface height of the first region is different from a surface height of the second region; calculating N feature values of the image according to a relative positional relationship between the first region and the second region, where N is greater than or equal to 1; determining a displacement correction value of the shadowless light source according to the N feature values, in response to the N feature values not meeting a predetermined condition; and adjusting a position of the shadowless light source according to the displacement correction value to re-capture the image and re-calculate the N feature values until the N feature values meet the predetermined condition.

In some embodiments, the method further includes: pre-establishing a functional relationship between the N feature values and the displacement correction value; where the determining a displacement correction value of the shadowless light source includes: determining the displacement correction value according to the functional relationship.

In some embodiments, the target object is any type of object in M types of objects, and the M types of objects are different in term of the relative positional relationship between the first region and the second region, where M is greater than or equal to 2; the pre-establishing a functional relationship between the N feature values and the displacement correction value includes: pre-establishing M functional relationships respectively corresponding to the M types of objects.

In some embodiments, the method further includes: before determining the displacement correction value according to the functional relationship, determining a type of the target object; and determining the functional relationship corresponding to the type of the target object.

In some embodiments, the target object has a first side facing the shadowless light source, the first region and the second region are located on the first side, the surface height includes a distance between a region surface and a second side of the target object, and the second side is opposite to the first side; and the surface height of the first region being different from the surface height of the second region includes: a first distance between at least part of a surface of the first region and the second side is different from a second distance between at least part of a surface of the second region and the second side.

In some embodiments, the N feature values include at least one selected from: a shadow width, including a maximum length of a shadow region in a first direction in the image; a shadow area, including an area of the shadow region; or a brightness difference, obtained according to a difference between an average grayscale value of at least part of the first region in the image and an average grayscale value of at least part of the second region in the image.

In some embodiments, the first region is connected to the second region, and the calculating N feature values of the image includes: determining a position of a reference point on the target object in the image; determining a first region of interest in the image according to the position of the reference point, where the first region of interest includes a connecting portion between the first region and the second region; and calculating the shadow width in the first region of interest.

In some embodiments, the calculating the shadow width in the first region of interest includes: calculating an average grayscale value in the first region of interest; multiplying the average grayscale value in the first region of interest by a binarization coefficient to obtain a binarization threshold; binarizing the first region of interest according to the binarization threshold; and determining the shadow region and the maximum length of the shadow region in the first direction according to a result of the binarizing, where an average grayscale value of the shadow region is greater than an average grayscale value of a remaining region in the first region of interest.

In some embodiments, the predetermined condition includes a first threshold of the shadow width, and the determining a displacement correction value of the shadowless light source according to the N feature values includes: determining the displacement correction value according to a pre-established functional relationship between the shadow width and the displacement correction value, in response to the shadow width being greater than the first threshold.

In some embodiments, the pre-established functional relationship between the shadow width and the displacement correction value is obtained by: before acquiring the image, adjusting the position of the shadowless light source S times in response to the shadow width being greater than or less than the first threshold, where S is greater than or equal to 2; recording each adjusted position of the shadowless light source and the shadow width corresponding to each adjusted position; and fitting S adjusted positions of the shadowless light source and the shadow widths corresponding to the adjusted positions, so as to obtain the functional relationship between the shadow width and the displacement correction value.

In some embodiments, the calculating N feature values of the image includes: obtaining the shadow area according to a number of pixels in the shadow region.

In some embodiments, the calculating N feature values of the image includes: determining a position of a reference point on the target object in the image; determining a second region of interest in the first region and a third region of interest in the second region in the image according to the position of the reference point; and calculating a brightness difference between the second region of interest and the third region of interest.

In some embodiments, the calculating a brightness difference between the second region of interest and the third region of interest includes: determining a first brightness-sensitive region in the second region of interest and a second brightness-sensitive region in the third region of interest, where a brightness-sensitive region has a greater reflectivity than a non-brightness-sensitive region; and calculating a brightness difference between the first brightness-sensitive region and the second brightness-sensitive region.

In some embodiments, the predetermined condition includes a second threshold of the brightness difference, and the determining a displacement correction value of the shadowless light source according to the N feature values includes: determining the displacement correction value according to a pre-established functional relationship between the brightness difference and the displacement correction value, in response to the brightness difference being greater than the second threshold.

In some embodiments, the pre-established functional relationship between the brightness difference and the displacement correction value is obtained by: before acquiring the image, adjusting the position of the shadowless light source K times in response to the brightness difference being greater than or less than the second threshold, where K is greater than or equal to 2; recording each adjusted position of the shadowless light source and the brightness value corresponding to each adjusted position; and fitting K adjusted positions of the shadowless light source and the brightness values corresponding to the adjusted positions, so as to obtain the functional relationship between the brightness value and the displacement correction value.

In some embodiments, the method further includes: before capturing the image of the target object, obtaining a current coordinate of a reference point on the target object, where the reference point is used to determine a position of at least one of the first region and the second region; and moving the target object so that the current coordinate coincides with a predetermined coordinate, in response to the current coordinate being inconsistent with the predetermined coordinate.

In some embodiments, the first region has a flat surface, the second region has an arc-shaped surface, and at least part of the arc-shaped surface is higher than the flat surface.

In some embodiments, the target object includes a display device, and the capturing an image of a target object includes: capturing an image of at least part of a pad region of the display device, where the at least part of the pad region includes a plane region of a chip-on-film and a bending region of the chip-on-film, the first region includes the plane region, and the second region includes the bending region.

In some embodiments, the shadowless light source includes a bowl-shaped light source.

In another aspect, embodiments of the present disclosure provide an apparatus of acquiring an image, for performing the method of acquiring the image as described above, the apparatus including: a shadowless light source located on a side of a target object; an image acquisition device configured to capture an image of the target object with lighting of the shadowless light source, where the image contains a first region of the target object and a second region of the target object, and a surface height of the first region is different from a surface height of the second region; an image processing device configured to: calculate N feature values of the image according to a relative positional relationship between the first region and the second region, where N is greater than or equal to 1; and determine a displacement correction value of the shadowless light source according to at least one of the N feature values, in response to the at least one feature value not meeting a predetermined condition; and a movable mechanism connected to the shadowless light source, where the movable mechanism is configured to adjust a position of the shadowless light source according to the displacement correction value so that the image acquisition device re-captures the image and the image processing device re-calculates the N feature values until the N feature values meet the predetermined condition.

In another aspect, embodiments of the present disclosure provide a method of detecting a defect, including: obtaining an image of a target object according to the method described above; and processing the image using a defect detection model to obtain a defect detection result output by the defect detection model.

In some embodiments, the target object includes a display device, the image includes at least part of a pad region of the display device, and the at least part of the pad region includes a plane region of a chip-on-film and a bending region of the chip-on-film, the method further including pre-processing the image before processing the image using the defect detection mode, wherein pre-processing the image comprises: determining a position of a reference point on the at least part of the pad region in the image; determining a fourth region of interest according to the position of the reference point, where the fourth region of interest includes a wire region on the at least part of the pad region; and processing the fourth region of interest to extract a boundary of a wire, where the defect detection model is configured to perform a defect detection on the wire.

### BRIEF DESCRIPTION OF THE DRAWINGS

With following description of the present disclosure with reference to the accompanying drawings, other objectives and advantages of the present disclosure may be obvious and the present disclosure may be understood comprehensively.

FIG. 1 shows a schematic diagram of a display device according to embodiments of the present disclosure;

FIG. 2 shows a schematic diagram of a display panel according to embodiments of the present disclosure;

FIG. 3 shows a schematic plan view of a chip-on-film according to some embodiments of the present disclosure;

FIG. 4 shows a schematic plan view of a chip-on-film according to other embodiments of the present disclosure;

FIG. 5 schematically shows a schematic diagram of bending a chip-on-film according to some embodiments of the present disclosure;

FIG. 6a and FIG. 6b schematically show images acquired using conventional capturing methods in the related art;

FIG. 7 schematically shows non-ideal images acquired with lighting of a shadowless light source according to some embodiments of the present disclosure;

FIG. 8 schematically shows a flowchart of a method of acquiring an image according to some embodiments of the present disclosure;

FIG. 9 schematically shows an ideal image with lighting of a shadowless light source according to some embodiments of the present disclosure;

FIG. 10 schematically shows a flowchart of determining a displacement correction value according to some embodiments of the present disclosure;

FIG. 11 schematically shows a flowchart of calculating a shadow width according to some embodiments of the present disclosure;

FIG. 12 schematically shows a visualization diagram of calculating a shadow width according to some embodiments of the present disclosure;

FIG. 13 schematically shows a flowchart of establishing a functional relationship between a shadow width and a displacement correction value according to some embodiments of the present disclosure;

FIG. 14 schematically shows a flowchart of calculating a brightness difference according to some embodiments of the present disclosure;

FIG. 15 schematically shows a visualization diagram of calculating a brightness difference according to some embodiments of the present disclosure;

FIG. 16 schematically shows a structural diagram of an apparatus of acquiring an image according to some embodiments of the present disclosure;

FIG. 17 schematically shows a flowchart of a method of detecting a defect according to some embodiments of the present disclosure;

FIG. 18 schematically shows a flowchart of training and deploying a defect detection model according to some embodiments of the present disclosure; and

FIG. 19 schematically shows a flowchart of performing an image acquisition and a defect detection according to some embodiments of the present disclosure.

It should be noted that for the sake of clarity, in the accompanying drawings used to describe embodiments of the present disclosure, sizes of layers, structures or regions may be enlarged or reduced, that is, these accompanying drawings are not drawn according to actual scale.

Some reference numerals involved in the accompanying drawings are provided as follows:
100. chip-on-film; 200. display panel; 300. circuit board; 110. plane region; 120. bending region; 201. gate signal input terminal; 202. data signal input terminal; 500. PAD detection region; 501. wire region; 1210. T-shaped reference point; 1220. first region of interest; 1510. cross-shaped reference point; 1520. second region of interest; 1530. third region of interest.

### DETAILED DESCRIPTION OF EMBODIMENTS

In the following description, for the purpose of explanation, many specific details are set forth to provide a comprehensive understanding of various exemplary embodiments. However, it is obvious that the various exemplary embodiments may be implemented without these specific details or with one or more equivalent arrangements. In other cases, well-known structures and devices are shown in block diagrams in order to avoid unnecessarily obscuring the various exemplary embodiments. In addition, the various exemplary embodiments may be different, but need not be exclusive. For example, without departing from the inventive concept, a specific shape, configuration and characteristic of an exemplary embodiment may be used or implemented in another exemplary embodiment.

In the accompanying drawings, for clarity and/or description purposes, sizes and relative sizes of elements may be enlarged. Accordingly, the size and relative size of each element need not to be limited to those shown in the accompanying drawings. When the exemplary embodiments may be implemented differently, the specific process sequence may be different from the sequence described. For example, two consecutively described processes may be performed substantially simultaneously or in a reverse order. In addition, the same reference numeral represents the same element.

When an element is described as being “on”, “connected to” or “coupled to” another element, the element may be directly on the another element, directly connected to the another element, or directly coupled to the another element, or an intermediate element may be provided. However, when an element is described as being “directly on”, “directly connected to” or “directly coupled to” another element, no intermediate element is provided. Other terms and/or expressions used to describe the relationship between elements, for example, “between” and “directly between”, “adjacent” and “directly adjacent”, “on” and “directly on”, and so on, should be interpreted in a similar manner. In addition, the term “connection” may refer to a physical connection, an electrical connection, a communication connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other.

It should be understood that, although terms “first,” “second” and so on may be used herein to describe different elements, those elements should not be limited by those terms. Those terms are just used to distinguish one element from another element. For example, without departing from the scope of the exemplary embodiments, a first element may be named as a second element, and similarly, a second element may be named as a first element.

In embodiments of the present disclosure, “a plurality of” means two or more, and “at least one” means one or more, unless otherwise specified.

Herein, the expression “PAD” refers to a pad region.

Herein, the expression “pin” refers to a portion of a chip-on-film that is electrically connected to other leads, wires, electrodes, etc., and it includes but is not limited to the PAD on the chip-on-film.

Herein, the expression “wire” refers to a signal line used for transmitting a signal.

Herein, the expression “bowl-shaped light source” refers to a diffuse reflective shadowless light source that is implemented based on a bowl-shaped structure.

Herein, the expression “brightness-sensitive region” refers to a region having a greater reflectivity compared to a non-brightness-sensitive region. The reflectivity indicates an ability to reflect light, and the greater the reflectivity, the higher the surface brightness.

Some embodiments of the present disclosure provide a method of acquiring an image, including: capturing an image of a target object with lighting of a shadowless light source, where the image contains a first region of the target object and a second region of the target object, and a surface height of the first region is different from that of the second region; calculating N feature values of the image according to a relative positional relationship between the first region and the second region; determining a displacement correction value of the shadowless light source according to the N feature values when the N feature values do not meet a predetermined condition; and adjusting a position of the shadowless light source according to the displacement correction value to re-capture the image and re-calculate the N feature values until the N feature values meet the predetermined condition.

In some embodiments of the present disclosure, it is possible to reduce a shadow with lighting of the shadowless light source. N feature values of the captured image is calculated to determine whether the image meets requirements. If not, it is possible to determine the displacement correction value of the shadowless light source according to the N feature values, then adjust the position of the shadowless light source in real time and re-capture the image, then re-calculate the N feature values and re-determine whether the N feature values meet the predetermined condition. The operations may be repeatedly performed until the image meets requirements. Therefore, by automatically correcting the position of the shadowless light source to determine an optimal lighting position for the target object, it is possible to achieve a good image acquisition effect, and avoid shadows, blurring, or uneven brightness in the image, which is beneficial for subsequent image processing operations.

For the sake of clear description and understanding, an image acquisition and a defect detection of a display device will be illustrated below by way of example in describing a method of acquiring an image, an apparatus of acquiring an image, and a method of detecting a defect in some embodiments of the present disclosure. It should be noted that the present disclosure is not limited to an image acquisition and processing scenario of a display device, but may also be applied to, for example, an image acquisition and a defect detection of an irregular workpiece, an image acquisition and a target recognition in a multi-object stacking scenario, or an object processing, assembly or sorting scenario implemented by an industrial robot based on machine vision.

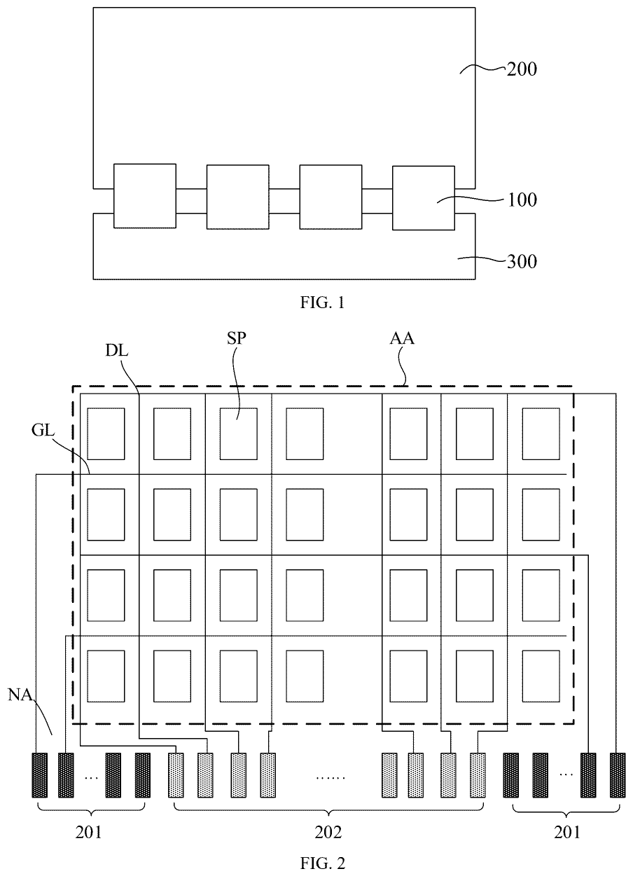

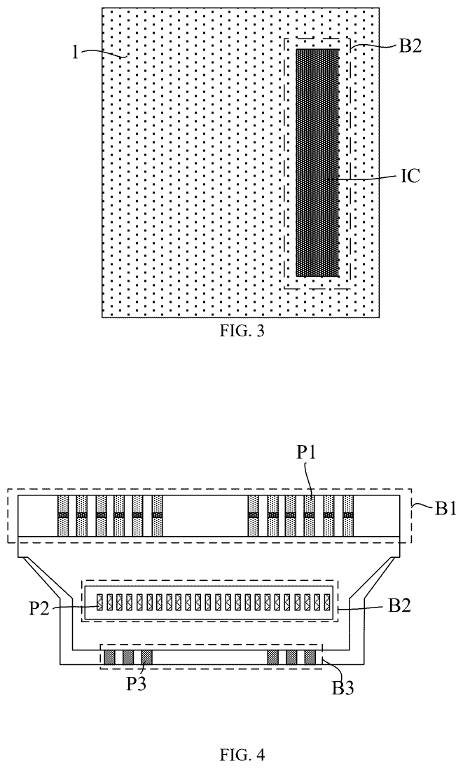

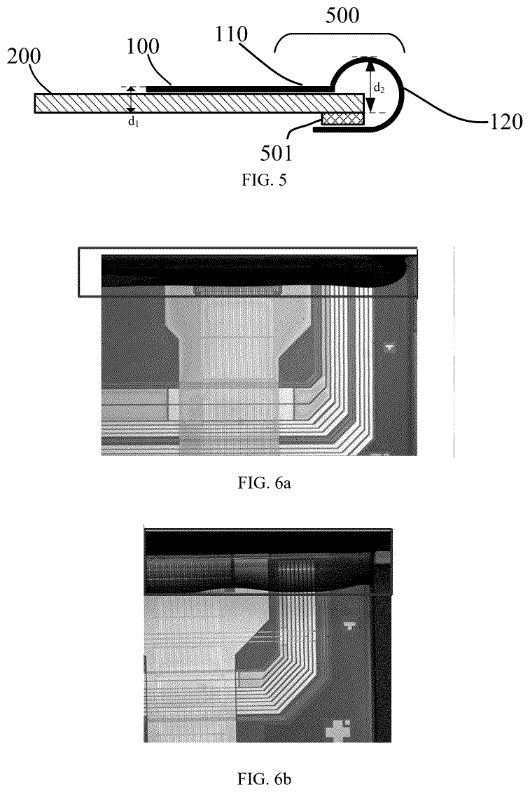

FIG. 1 shows a schematic diagram of a display device according to embodiments of the present disclosure. FIG. 2 shows a schematic diagram of a display panel according to embodiments of the present disclosure. FIG. 3 shows a schematic plan view of a chip-on-film according to some embodiments of the present disclosure. FIG. 4 shows a schematic plan view of a chip-on-film according to other embodiments of the present disclosure.

Referring to FIG. 1 to FIG. 4, the display device may include a display panel 200, a chip-on-film 100, and a circuit board 300. The display panel 200 is electrically connected to the circuit board 300 through the chip-on-film 100. For example, the display panel 200 may include a display region AA and a peripheral region NA, and the peripheral region NA is arranged, for example, around the display region AA. In some exemplary embodiments, a plurality of sub-pixels SP may be provided in the display region.

FIG. 2 illustrates an arrangement of the plurality of sub-pixels SP in an array form as an example. In this case, sub-pixels SP arranged in a horizontal row may be referred to as a row of sub-pixels, and sub-pixels SP arranged in a vertical column may be referred to as a column of sub-pixels. Optionally, a row of sub-pixels may be connected to a gate line GL, and a column of sub-pixels may be connected to a data line DL. On this basis, in some embodiments of the present disclosure, as shown in FIG. 2, the display panel 200 may further include a plurality of gate signal input terminals 201 and a plurality of data signal input terminals 202.

As shown in FIG. 2, for a single-side-drive display panel 200, the data signal input terminals 202 and the gate signal input terminals 201 are arranged on a same side of the display panel 200. The data signal input terminals 202 are arranged at a middle position, and the gate signal input terminals 201 are arranged at an edge position.

In some embodiments of the present disclosure, the data signal input terminals 202 are electrically connected to the data lines DL on the display panel 200, and the gate signal input terminals 201 are electrically connected to the gate lines GL.

In this case, both the gate signal input terminals 201 and the data signal input terminals 202 on the display panel 200 may be bound to the circuit board 300 through the chip-on-film 100, so that an electrical signal may be transmitted from the circuit board 300 to the display panel 200.

It should be noted that a type of the display panel 200 is not specifically limited in embodiments of the present disclosure. The display panel 200 may be a TN (Twisted Nematic), VA (Vertical Alignment), IPS (In-Plane Switching) or ADS (Advanced Super Dimension Switch) liquid crystal display panel 200, or may be an OLED (Organic Light-Emitting Diode) display panel 200.

For example, the circuit board 300 may be FPC (Flexible Printed Circuit) or PCB (Printed Circuit Board).

Embodiments of the present disclosure provide a chip-on-film 100. As shown in FIG. 3 and FIG. 4, the chip-on-film 100 may include a flexible substrate 1.

For example, a material of the flexible substrate 1 may include PI (Polyimide), PA (Polyamide), or PBO (Poly-p-phenylene benzobisoxazole), etc.

In embodiments of the present disclosure, the chip-on-film 100 may include a plurality of binding regions located on the flexible substrate 1. For example, referring to FIG. 3, the plurality of binding regions may include at least one chip binding region B2, which is used to bind to a chip. Alternatively, the plurality of binding regions may include a plurality of chip binding regions B2, which are respectively bound to a plurality of chips IC. That is to say, in such embodiments, a plurality of chips IC may be provided on a chip-on-film 100, and a plurality of chip binding regions B2 correspond to the plurality of chips IC respectively.

For example, referring to FIG. 4, the plurality of binding regions may include a panel binding region B1, a chip binding region B2, a circuit board binding region B3, and other non-binding regions (regions not enclosed by dashed lines in FIG. 4). For example, the panel binding region B1 is used to bind to the display panel 200, the chip binding region B2 is used to bind to the chip, and the circuit board binding region B3 is used to bind to the circuit board 300. In such embodiments, the numbers of the panel binding region B1, the chip binding region B2 and the circuit board binding region B3 are not specifically limited. For example, a plurality of chip binding regions B2 may be provided to bind to a plurality of chips IC respectively.

In embodiments of the present disclosure, a plurality of pins may be provided in each binding region of the chip-on-film 100. For example, in the panel binding region B1, a plurality of pins P1 may be provided to bind to corresponding pins on the display panel 200. In the chip binding region B2, a plurality of pins P2 may be provided to bind to corresponding pins on the chip IC. In the circuit board binding region B3, a plurality of pins P3 may be provided to bind to corresponding pins on the circuit board.

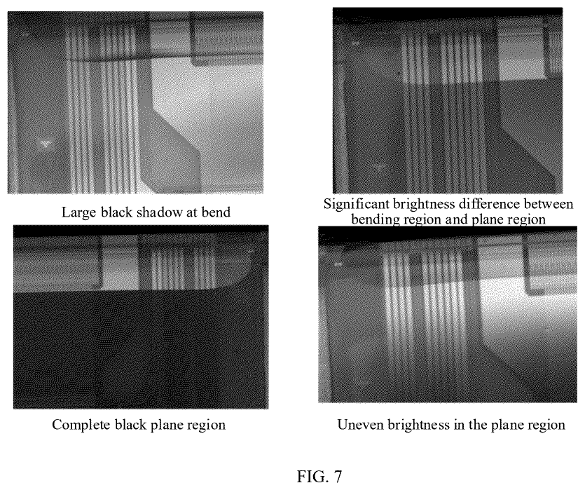

FIG. 5 schematically shows a schematic diagram of bending the chip-on-film 100 according to some embodiments of the present disclosure. FIG. 6 a and FIG. 6 b schematically show images acquired using conventional capturing methods in the related art. FIG. 7 schematically shows non-ideal images acquired with lighting of a shadowless light source according to some embodiments of the present disclosure.

In embodiments of the present disclosure, as shown in FIG. 5, the chip-on-film 100 on the display panel 200 is folded and attached to a wire region 501 on a back of the display panel 200, thereby forming a plane region 110 fitting to the display panel 200 and a bending region 120. The plane region 110 has a flat surface, and the bending region 120 has an arc-shaped surface. A top of the bending region 120 has a distance d from the display panel 200, for example, a distance of 0.3 mm˜0.5 mm (just for example).

Continuing to refer to FIG. 5, due to the presence of the plane region 110, the bending region 120, and a connecting portion between the two, the chip-on-film 100 is prone to generate defects. Therefore, a PAD detection region 500 is defined for an image acquisition and a defect detection. The PAD detection region 500 includes at least part of the plane region 110, at least part of the bending region 120, and the connecting portion.

As shown in FIG. 6a and FIG. 6b, due to the presence of the bending region 120, it is difficult to simultaneously meet the image acquisition requirements of both the plane region 110 and the bending region 120 using conventional capturing methods. It is difficult to capture a clear image of the bending region 120 using a shadowy light source (such as point light source, ring light, strip light, etc.), and it is easy to cause a missed detection of defects.

A shadowless light source may be used to reduce shadows. However, images acquired with different lighting positions may have different qualities, or images acquired for different products (for example, with different bending directions, different display device sizes, or different bending angles) with the same lighting position may have different qualities. As shown in FIG. 7, the acquired images respectively have a large black shadow at a bend, a significant brightness difference between a bending region and a plane region, a complete black plane region, or an uneven brightness in the plane region. The method of acquiring the image in which a position of a shadowless light source may be automatically adjusted will be further described below.

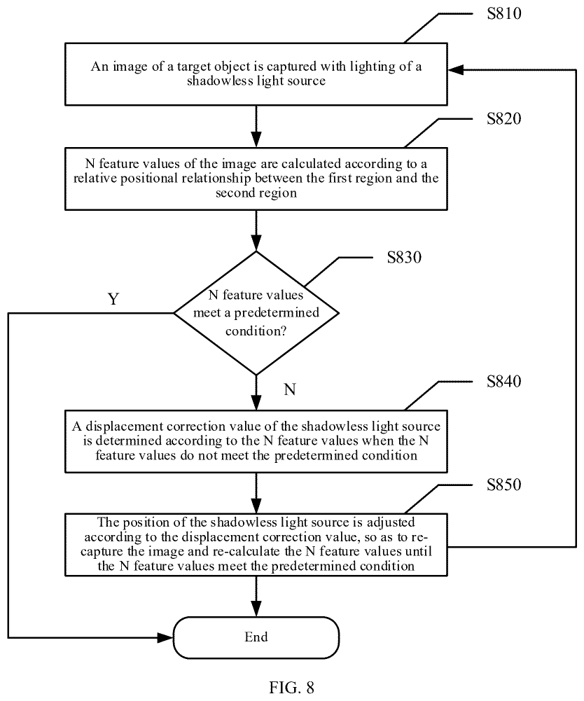

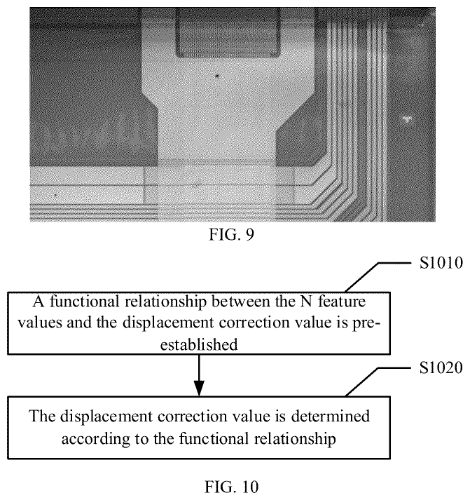

FIG. 8 schematically shows a flowchart of a method of acquiring an image according to some embodiments of the present disclosure. FIG. 9 schematically shows an ideal image with lighting of a shadowless light source according to some embodiments of the present disclosure.

As shown in FIG. 8, the method of acquiring the image of such embodiments includes operation S810 to operation S840.

In operation S810, an image of a target object is captured with lighting of a shadowless light source, where the image contains a first region of the target object and a second region of the target object, and a surface height of the first region is different from that of the second region.

For example, the first region and the second region may be connected and both have flat surfaces, similar to a stepped shape. Due to a height difference between the surface height of the first region and the surface height of the second region, a shadow may still be formed in some regions under light emitted by the shadowless light source.

For another example, the first region may be close to the second region, with one having a flat surface and the other having a non-flat surface. At least partial shadow of the non-flat surface may be mapped onto the flat surface under light. In some embodiments, the first region has a flat surface, the second region has an arc-shaped surface, and at least part of the arc-shaped surface is higher than the flat surface.

In some embodiments, the target object includes a display device, and capturing the image of the target object includes: capturing at least part of a pad region of the display device. The at least part of the pad region includes the plane region 110 and the bending region 120 of the chip-on-film 100. The first region includes the plane region 110, and the second region includes the bending region 120.

It may be understood that the target object having the flat surface and the arc-shaped surface is not limited to the PAD detection region 500 of the display screen, but may also include other irregular workpieces or other products, such as a semiconductor substrate, an electronic part, a rubber part, or a mechanical part.

In some embodiments, the shadowless light source includes a bowl-shaped light source. For example, LED particles may be used in the bowl-shaped light source, and a smooth and uniform illumination may be formed through a spherical diffuse reflection. With lighting of the bowl-shaped light source, both the first region and the second region may be taken into account in the image acquisition. It may be understood that in the present disclosure, the shadowless light source is not limited to a bowl-shaped light source, but may also include a dome shadowless light source, a ring shadowless light source, a rectangular shadowless light source, a plane shadowless light source, or a multiple-face shadowless light source.

In some embodiments, the target object has a first side facing the shadowless light source, and the first region and the second region are located on the first side. The surface height includes a distance between a region surface and a second side of the target object, and the second side is opposite to the first side. The surface height of the first region being different from the surface height of the second region includes: a first distance between at least part of the surface of the first region and the second side is different from a second distance between at least part of the surface of the second region and the second side.

Taking the target object being a display device as an example, referring to FIG. 5, the PAD detection region 500 is located on the first side, and a bottom plane of the display panel 200 (for example, a bottom of a base substrate) is the second side. Measured in a direction perpendicular to the display panel 200, the surface height of the first region is a first distance d₁, and a maximum surface height of the second region is a second distance d₂, which is different from d₁. As shown in FIG. 5, d₂ is greater than d₁. In other embodiments, for example, the target object may be of another type, and d₂ may be less than d₁.

In operation S820, N feature values of the image are calculated according to a relative positional relationship between the first region and the second region, where N is greater than or equal to 1.

For example, a feature value may indicate an image feature, and may serve as an image attribute to determine whether the image meets requirements. The N feature values may include a feature value of color, a feature value of texture (such as a texture shape, a texture area, a matching degree between a texture in the image and a texture of an actual object), a feature value of shadow, a feature value of brightness, a feature value of specific region shape, and a feature value of relative position of regions.

In some embodiments, the relative positional relationship includes an orientation of the position of the first region relative to the position of the second region and/or a relationship between the surface heights of the two regions. Due to the height difference between at least part of the surface of the first region and at least part of the surface of the second region, after receiving the lighting of the shadowless light source, the first region, the second region, and the connecting portion between the two regions may have inconsistent image attributes (such as the above feature values). Referring to FIG. 5, the chip-on-film 100 is bent in a left-right direction, forming a plane region 110 and a bending region 120 having a left-right relative positional relationship. The shadows, uneven brightness or blurring formed in the acquired image are related to the left-right relative position and the right arc-shaped surface being higher than the left flat surface. Therefore, the N feature values to be calculated may be determined based on the image problems generated by the left-right relative position.

In other embodiments, for example, taking the orientation shown in FIG. 5 as a reference orientation, different from the left-right bending shown in FIG. 5, the first region and the second region may be formed by up-down bending and may be considered to have an up-down relative positional relationship, or may be formed by bending along diagonal and may be considered to have an oblique relative positional relationship, or may be formed by bending in other ways and have other corresponding positional relationships. Due to the difference in the relative positional relationship, the regions may have different brightness, the angle of light reflection may result in different shapes or areas of shadows, and even shapes, colors and textures of specific regions may change. Therefore, possible image problems during acquisition may be considered according to the specific relative positional relationship, and the N feature values may be determined accordingly. In other words, different relative positional relationships may correspond to at least partially different N feature values.

In other embodiments, the N feature values may be determined not only depending on the specific relative positional relationship, but also by considering a shape of the shadowless light source, a distance between the shadowless light source and any region (the first region or the second region), and an influence of the relative position on the image quality. For example, a field of view of uniform light emitted by the shadowless light source varies with its shape, distance and relative position, so that the light illuminating a particular region may be affected.

In other embodiments, the target object may have a third region. Any of the first region, the second region and the third region may have a surface height different from at least one of the other regions. The region having a higher surface may generate a shadow in the other two regions. The N feature values may be determined according to the relative positional relationships between each two of the first region, the second region and the third region. It may be understood that according to different detection ranges on the target object, the target object may have more regions, such as a fourth region and a fifth region, and the N feature values may be determined according to the relative positional relationships between each two of a plurality of regions.

In operation S830, it is determined whether the N feature values meet a predetermined condition. If so, the image acquisition ends. If not, operation S840 is executed.

In operation S840, a displacement correction value of the shadowless light source is determined according to the N feature values when the N feature values do not meet the predetermined condition.

For example, the displacement correction value includes a movement distance of the shadowless light source from a current position to a target position. The predetermined condition may include that each feature value is within a predetermined numerical range. When the N feature values meet the predetermined condition, it is considered that the captured image of the target object meets requirements. If any of the N feature values is outside the predetermined numerical range, or if the number of feature values outside the predetermined numerical range is greater than a particular number, it is considered that the N feature values do not meet the predetermined condition.

If one or more feature values are not within the corresponding numerical range, the displacement correction value may be determined to adjust the position of the shadowless light source, and then the image may be re-acquired.

In some embodiments, it is possible to obtain historical data, and determine a movement direction and the displacement correction value based on a movement trajectory of the shadowless light source in the historical data when the current feature value does not meet the predetermined condition.

In other embodiments, a three-dimensional lighting simulation space may be built according to the shadowless light source, the target object, the positions of the two, and the shapes of the two. With the image captured in operation S810 as a lighting reference in the three-dimensional lighting simulation space, it is possible to simulate light changes and captured images corresponding to a plurality of movement trajectories, simulate the calculation of feature values to determine an optimal movement trajectory, and finally determine the displacement correction value according to the optimal movement trajectory.

In operation S850, the position of the shadowless light source is adjusted according to the displacement correction value, so as to re-capture the image and re-calculate the N feature values until the N feature values meet the predetermined condition.

Referring to FIG. 8, if the captured image still does not meet requirements after the adjustment of the position, operation S810 to operation S850 may be repeated. Referring to FIG. 9, an ideal image that takes into account both the plane region 110 and the bending region 120 in the PAD detection region 500 is shown, which is an image that meets requirements. It may be understood that it is possible to adjust the position of the shadowless light source within a horizontal plane, or adjust a height of the shadowless light source, which is not limited in the present disclosure.

According to embodiments of the present disclosure, by automatically correcting the position of the shadowless light source to determine an optimal lighting position for the target object, it is possible to achieve a good image acquisition effect, and avoid shadows, blurring, or uneven brightness in the image, which is beneficial for subsequent image processing operations.

In some embodiments, it is possible to obtain a current coordinate of a reference point on the target object before capturing the image of the target object. The reference point is used to determine the position of at least one of the first region and the second region. When the current coordinate is inconsistent with a predetermined coordinate, the target object may be moved so that the current coordinate coincides with the predetermined coordinate.

For example, the target object may be placed on a stage, and an image alignment is performed firstly. The reference point includes a fixed coordinate point on the target object, which may be a manual mark or may be formed when manufacturing the target object. The reference point has a fixed relative position with the first region and the second region. During the image alignment process, the target object may be moved by moving the stage or by moving the position of the target object on an inspection station. Various parameters of the capturing device may have been adjusted before capturing images, and it is possible to avoid re-adjustment of parameters and save time by moving the target object.

According to embodiments of the present disclosure, with the image alignment before capturing images, a capture region such as the PAD detection region 500 may be accurately determined through the reference point, so that an error of the capture region may be minimized or eliminated. In addition, the use of the coordinate of the reference point may facilitate the subsequent determination of the positions of the first region and the second region, the calculation of the feature values, and the adjustment of the position of the shadowless light source, thereby optimizing an image acquisition time and an image acquisition effect.

FIG. 10 schematically shows a flowchart of determining a displacement correction value according to some embodiments of the present disclosure.

As shown in FIG. 10, determining the displacement correction value of the shadowless light source in such embodiments includes operation S1010 to operation S1020. Operation S1020 is an embodiment of operation S840.

In operation S1010, a functional relationship between the N feature values and the displacement correction value is pre-established.

For example, the functional relationship includes a corresponding relationship between a displacement variation (i.e., the displacement correction value) and N feature value variations. The functional relationship may include a total of N relational expressions between each feature value and the displacement correction value. Each relational expression may contain one or more independent variables, such as an angle and a distance of the shadowless light source relative to the target object, the relative position between the first region and the second region (such as relative angle and height difference), in addition to the displacement correction value. A dependent variable is a feature value.

In operation S1020, the displacement correction value is determined according to the functional relationship.

For example, for a feature value that does not meet the predetermined condition, a corresponding relational expression may be determined, and a variation of the feature value that meets the predetermined condition is provided and substituted into the corresponding relational expression to solve for the displacement correction value. After solving for the displacement correction value, the displacement correction value may be substituted into other relational expressions to calculate corresponding feature values, which are then compared with corresponding predetermined conditions.

In other embodiments, the functional relationship may include a mathematical model that is built and trained based on a machine learning algorithm, such as a classification model trained using a process of adjusting the shadowless light source in the historical data and the corresponding changes in feature values. The calculated N feature values may be input into the model to output a classification of the movement direction of the shadowless light source, such as forward, backward, leftward, and rightward. The shadowless light source may be moved step by step according to a fixed movement distance based on a classification result.

According to embodiments of the present disclosures, the displacement correction value may be automatically determined according to the pre-established functional relationship, so that a speed and an accuracy of the position adjustment may be improved.

In some embodiments, the target object is any type of object in M types of objects. The M types of objects are different in term of the relative positional relationship between the first region and the second region, where M is greater than or equal to 2. Operation S1010 further includes pre-establishing M functional relationships respectively corresponding to the M types of objects.

For example, the M types of objects may be M types of display devices, which may respectively have, for example, a chip-on-film 100 that is bent in an anterior-posterior direction, a chip-on-film 100 that is bent in the left-right direction, a chip-on-film 100 that is bent along diagonal, or a chip-on-film 100 that is bent at multiple positions, etc., so that the plane region 110 and the bending region 120 on the chip-on-film 100 of each type of display device have different relative positional relationship. It may be understood that the M types of objects may include different types of products, such as display devices and irregular workpieces. The functional relationship between the N feature values of the captured image and the displacement correction value may be established for each type of object.

When lighting by the shadowless light source, the optimal lighting position may be different for different types (such as shapes) of objects. Taking a display device as an example, the difference in products, the difference in bending radii and bending curvatures of the bending region 120 of various products, the height difference of plane fitting regions, and other factors may cause imaging differences. When switching between image acquisitions of different types of objects, it is difficult to quickly adjust the position of the shadowless light source, which may restrict an efficiency of the image acquisition.

According to embodiments of the present disclosures, pre-establishing M functional relationships respectively corresponding to M types of objects may be adapted to image acquisitions of multiple types of objects, so that application scenarios may be expanded, and the efficiency of image acquisition may be improved.

In some embodiments, before determining the displacement correction value according to the functional relationship in operation S1020, the method further includes determining a type of the target object, and determining the functional relationship corresponding to the type of the target object. Its purpose is to determine a matched functional relationship to accurately determine the displacement correction value and achieve a good image acquisition quality.

In some embodiments, the N feature values include at least one selected from: a shadow width, including a maximum length of the shadow region in a first direction in the image; a shadow area, including an area of the shadow region; or a brightness difference, obtained according to a difference between an average grayscale value of at least part of the first region in the image and an average grayscale value of at least part of the second region in the image.

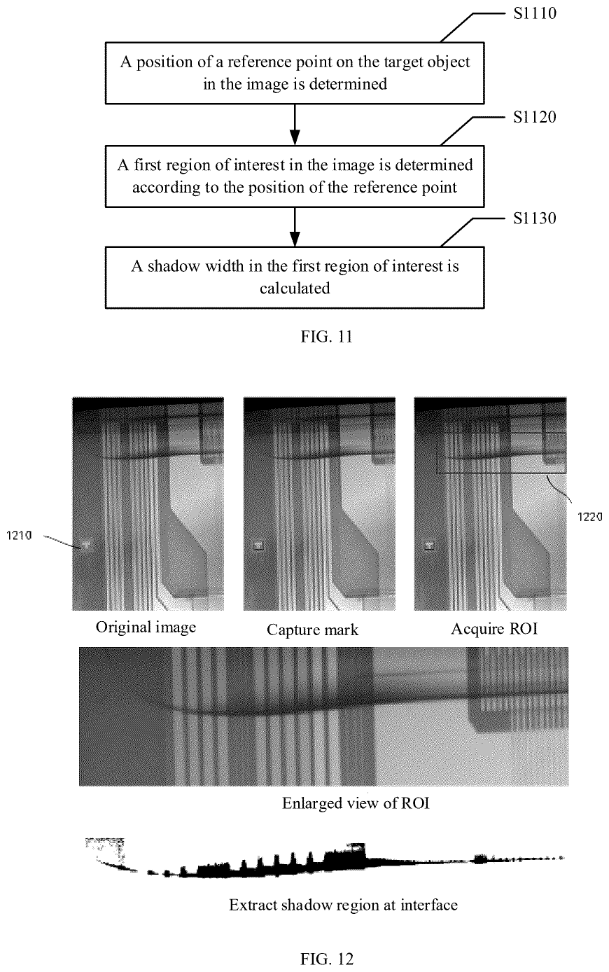

The shadow width, the shadow area and the brightness difference will be further described below with reference to FIG. 11 to FIG. 15 and some embodiments.

FIG. 11 schematically shows a flowchart of calculating a shadow width according to some embodiments of the present disclosure. FIG. 12 schematically shows a visualization diagram of calculating a shadow width according to some embodiments of the present disclosure.

Referring to FIG. 11 and FIG. 12, the first region and the second region are connected, and calculating the N feature values of the image includes operation S1110 to operation S1130.

In operation S1110, a position of a reference point on the target object in the image is determined.

Referring to FIG. 12, the bending region is located above, and the plane region is located below. Accordingly, an original image is obtained by a 90° rotation of at least part of the PAD detection region 500 in FIG. 5. A T-shaped reference point 1210 is in a shape of a “T”. Generally, a circuit region may be pre-provided with a cross or T-shaped metal mark point (i.e., the reference point) for convenience of detection. The mark point, like a metal wire (i.e., wire), has a lower grayscale value in the image than other non-metal regions in a dark field light environments. Through the difference in grayscale values, the mark point may be captured, so as to determine a coordinate value of the T-shaped reference point 1210.

An example of capturing the mark point is as follows. Gaussian filtering is performed on the original image to remove noise, and a binarization is performed on the image with a set threshold of 1. The binarized image is filtered according to morphological features (a size, an aspect ratio, etc. of the mark point), and then a center point (x4, y4) of the mark point is calculated. The center point may be, for example, an intersection point of a horizontal line and a vertical line in the “T”.

In operation S1120, a first region of interest 1220 in the image is determined according to the position of the reference point. The first region of interest 1220 includes a connecting portion between the first region and the second region.

The first region of interest 1220 is determined after the determination of the T-shaped reference point 1210. Referring to the acquisition of ROI (Region of Interest) in FIG. 12, a detection region of interest ROI is divided according to the center point of the mark point (because the mark point of a product is substantially fixed with respect to the bending region 120 of the product). The ROI includes an imaging region at an intersection of the plane region 110 and the bending region 120.

A size of the ROI is set to (width, height) according to a size of a region where a wire (such as a metal wire) is located. Then, with the center point (x3, y3) of the mark point as a reference point, an image of the ROI is cut from the original image to generate an ROI image. An enlarged view of the ROI image is shown in FIG. 12.

In operation S1130, a shadow width in the first region of interest 1220 is calculated.

According to embodiments of the present disclosure, due to the height difference, a shadow is prone to appear in the connecting portion. When the first region of interest 1220 is determined according to the position of the reference point and the size of the wire region in the chip-on-film 100, the shadow width in the first region of interest 1220 may be accurately calculated.

In some embodiments, calculating the shadow width in operation S1130 includes the following steps.

Firstly, an average grayscale value in the first region of interest 1220 is calculated. After performing a noise reduction on the ROI image shown in FIG. 12, an average grayscale value m1 of pixels in the ROI is calculated.

Then, the average grayscale value in the first region of interest 1220 is multiplied by a binarization coefficient to obtain a binarization threshold. A binarization is performed on the first region of interest 1220 according to the binarization threshold. Here, a binarization is performed on the ROI image shown in FIG. 12 according to a binarization threshold obtained by multiplying m1 by the binarization coefficient km (which is determined according to image features and generally less than 1). A pixel grayscale value lower than m1 is set to 255, and a pixel grayscale value higher than m1 is set to 0.

Finally, the shadow region and the maximum length of the shadow region in the first direction are determined according to a binarization result. The average grayscale value of the shadow region is greater than the average grayscale value of a remaining region in the first region of interest 1220.

If there is a shadow at the interface in the ROI, the pixel grayscale value in the shadow region is 255, and the pixel grayscale value in the remaining region is 0. Referring to FIG. 5 and FIG. 12, the first direction is the bending direction of the chip-on-film 100. A bounding rectangle of a region having a grayscale value of 255 (the shadow region at the interface shown in FIG. 12) may be found, and a height of the bounding rectangle is the shadow width K1 of the shadow region at the interface.

In some embodiments, the predetermined condition includes a first threshold of the shadow width, and determining the displacement correction value of the shadowless light source according to the N feature values in operation S840 includes: when the shadow width is greater than the first threshold, the displacement correction value is determined according to the pre-established functional relationship between the shadow width and the displacement correction value. By pre-establishing the functional relationship between the shadow width and the displacement correction value, it is possible to correct the position of the light source automatically, quickly and efficiently, so as to reduce the shadow width or even completely eliminate the shadow.

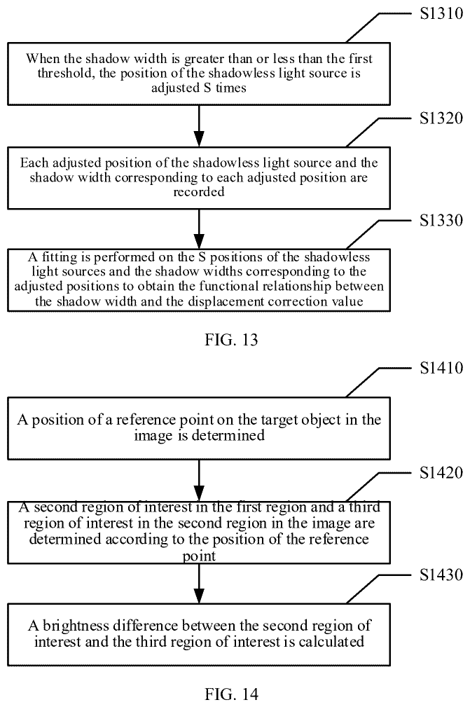

FIG. 13 schematically shows a flowchart of establishing a functional relationship between a shadow width and a displacement correction value according to some embodiments of the present disclosure.

In some embodiments, as shown in FIG. 13, pre-establishing the functional relationship between the shadow width and the displacement correction value before operation S810 to operation S840 are executed for image acquisition may include operation S1310 to operation S1330.

In operation S1310, when the shadow width is greater than or less than the first threshold, the position of the shadowless light source is adjusted S times, where S is greater than or equal to 2.

In operation S1320, each adjusted position of the shadowless light source and the shadow width corresponding to each adjusted position are recorded.

In operation S1330, a fitting is performed on the S positions of the shadowless light sources and the shadow widths corresponding to the adjusted positions to obtain the functional relationship between the shadow width and the displacement correction value.

In some embodiments, when K1 is greater than the first threshold, for example, greater than 7 pixels, it indicates that the shadowless light source is biased towards the bending region 120 in FIG. 5 and needs to be moved by a certain distance towards the plane region 110. With the current position of the shadowless light source as an origin, the shadowless light source is moved by a particular distance multiple times towards the plane region 110, the change in K1 value is recorded, and a fitting is performed on a displacement x1 (obtained from the positions of the shadowless light source before and after adjustment) and the change in the K1 value, thereby establishing a functional relationship between the feature value K1 and the displacement correction value. In other embodiments, when K1 is less than the first threshold, the shadowless light source may be gradually moved towards the bending region 120, the change in the K1 value may be recorded, and a fitting is performed on the displacement x1 and the change in the K1 value, thereby establishing a functional relationship between the feature value K1 and the displacement correction value.

In some embodiments, a fitting may be performed to obtain the functional relationship between the coordinate point (single coordinate axis) of the position of the shadowless light source and the K1 value. For example, it is possible to move the shadowless light source along any axis of XYZ coordinate axes, record the coordinate position and the K1 value, and finally perform a fitting to obtain three functional relationships respectively corresponding to the XYZ coordinate axes.

It should be noted that operation S1310 to operation S1320 are illustrated and explained in sequence, but they may also be executed simultaneously. For example, for each adjustment in operation S1310, operation S1320 is executed to record the adjusted position of the shadowless light source and calculate the shadow width in the captured image corresponding to that position.

In some embodiments, calculating the N feature values of the image in operation S820 includes: obtaining the shadow area according to the number of pixels in the shadow region (i.e., the shadow region at the interface) shown in FIG. 12. In other embodiments, it is possible to fit a contour of the shadow region and calculate an area of the contour.

According to embodiments of the present disclosure, if the shadow area is too large, it is determined that the acquired image does not meet requirements. Therefore, it is possible to obtain an optimal image by determining the shadow area.

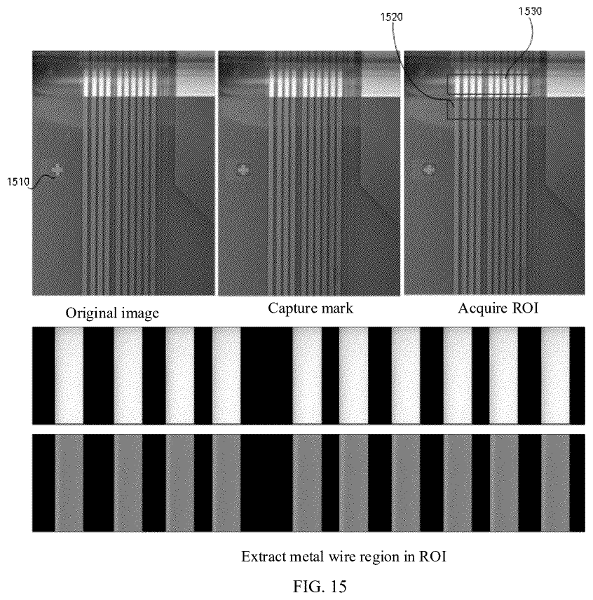

FIG. 14 schematically shows a flowchart of calculating a brightness difference according to some embodiments of the present disclosure. FIG. 15 schematically shows a visualization diagram of calculating a brightness difference according to some embodiments of the present disclosure.

In some embodiments, calculating the N feature values of the image in operation S820 includes operation S1410 to operation S1430.

In operation S1410, a position of a reference point on the target object in the image is determined. Reference may be made to operation S1110, which will not be repeated here.

In operation S1420, a second region of interest 1520 in the first region and a third region of interest 1530 in the second region in the image are determined according to the position of the reference point.

After a determination of a cross reference point 1510, the second region of interest 1520 and the third region of interest 1530 may be determined. Referring to the acquisition of ROI in FIG. 15, the second region of interest 1520 and the third region of interest 1530 are divided according to the center point of the mark point (a center of the cross shown in FIG. 15). The second region of interest 1520 and the third region of interest 1530 respectively contain imaging regions on both sides of the connecting portion between the first region and the second region.

In operation S1430, a brightness difference between the second region of interest 1520 and the third region of interest 1530 is calculated.

According to embodiments of the present disclosure, when lighting by the shadowless light source, a lighting position may cause uneven light in different regions and result in a brightness difference. Especially, the brightness difference begins at the connecting portion. Therefore, it is possible to accurately calculate the brightness difference by determining the second region of interest 1520 and the third region of interest 1530 on both sides of the connecting portion.

In some embodiments, calculating the brightness difference between the second region of interest 1520 and the third region of interest 1530 in operation S1430 includes: determining a first brightness-sensitive region in the second region of interest 1520 and a second brightness-sensitive region in the third region of interest 1530, where a brightness-sensitive region has a greater reflectivity than a non-brightness-sensitive region; and calculating a brightness difference between the first brightness-sensitive region and the second brightness-sensitive region.

For example, referring to the extraction of the metal wire region in the ROI shown in FIG. 15, because the metal wire region has a large brightness difference and a high reflectivity, firstly, the metal wire region in the second region of interest 1520 is found as the first brightness-sensitive region, and the metal wire region in the third region of interest 1530 is found as the second brightness-sensitive region.

Secondly, average pixel values m21 and m22 are respectively calculated for the second region of interest 1520 and the third region of interest 1530. With m21 and m22 as binarization thresholds, a binarization is performed on the image of the second region of interest 1520 and the image of the third region of interest 1530. A pixel grayscale value less than m21 and m22 is set to 255, and a pixel grayscale value greater than m1 is set to 0.

Then, as the metal wire region has a larger brightness value than a non-metal wire region, the pixel grayscale values in the metal wire region in the second region of interest 1520 and the third region of interest 1530 are 0. In order to eliminate interference from an edge of the metal wire, an opening and closing operation is performed on the image to denoise the image. The binarized images may be subtracted from the original images of the second region of interest 1520 and the third region of interest 1530 to obtain image21 and image22. Then, the pixel grayscale values in the metal wire region are retained as original values, while the pixel value in the non-metal wire region is 0.

Finally, an average grayscale value of pixels at the metal wire in the second region of interest 1520 and an average grayscale value of pixels at the metal wire in the third region of interest 1530 are respectively calculated to obtain a difference between the two. An average grayscale value of image21 and an average grayscale value of image22 are calculated, and an absolute value of a difference between the two is a brightness difference K2.

In some embodiments, the predetermined condition includes a second threshold of the brightness difference, and determining the displacement correction value of the shadowless light source according to the N feature values includes: when the brightness difference is greater than the second threshold, the displacement correction value is determined according to a pre-established functional relationship between the brightness difference and the displacement correction value. By pre-establishing the functional relationship between the brightness difference and the displacement correction value, it is possible to obtain a timely feedback according to the brightness difference, and output the displacement correction value to adjust the position of the light source, so that the brightness of the first region and the brightness of the second region tend to be consistent.

In some embodiments, pre-establishing the functional relationship between the brightness difference and the displacement correction value before operation S810 to operation S840 are executed for image acquisition includes: when the brightness difference is greater than or less than the second threshold, adjusting the position of the shadowless light source K times, where K is greater than or equal to 2; recording each adjusted position of the shadowless light source and the brightness difference corresponding to each adjusted position; performing a fitting on the K positions of the shadowless light source and the brightness differences corresponding to the adjusted positions, thereby obtaining the functional relationship between the brightness difference and the displacement correction value. For example, for each adjustment, the adjusted position of the shadowless light source and the brightness difference corresponding to the adjusted position may be recorded.

In some embodiments, when K2 is greater than the second threshold, for example, when the difference is 10 and the plane region 110 has a greater brightness, it indicates that the shadowless light source is biased towards the plane region 110 in FIG. 5, and needs to be moved by a certain distance towards the bending region 120. With the current position of the shadowless light source as an origin, the shadowless light source is moved by a particular distance multiple times towards the bending region 120, the change in K2 value is recorded, and a fitting is performed on a displacement x2 (obtained from the positions of the shadowless light source before and after adjustment) and the change in the K2 value, thereby establishing a functional relationship between the feature value K2 and the displacement correction value. In other embodiments, when K2 is less than the second threshold, the shadowless light source may be moved multiple times towards the plane region 110, the change in the K2 value may be recorded, and a fitting is performed on the displacement x2 and the change in the K2 value, thereby establishing a functional relationship between the feature value K2 and the displacement correction value.

In some embodiments, similar to the fitting of the shadow width, a fitting may be performed to obtain the functional relationship between the coordinate point (single coordinate axis) of the position of the shadowless light source and the K2 value. For example, it is possible to move the shadowless light source along any axis of XYZ coordinate axes, record the coordinate position and the K2 value, and finally perform a fitting to obtain three functional relationships respectively corresponding to the XYZ coordinate axes.

In some embodiments, if the N feature values include K1 and K2, then during the function fitting, it is possible to firstly adjust one of the feature values in the captured image to below the corresponding threshold, and then fit the function for the other feature value above the corresponding threshold. During the image acquisition, when both K1 and K2 are greater than the corresponding thresholds, the displacement correction value may be determined according to two functional relationships, so that both K1 and K2 are less than the corresponding thresholds.

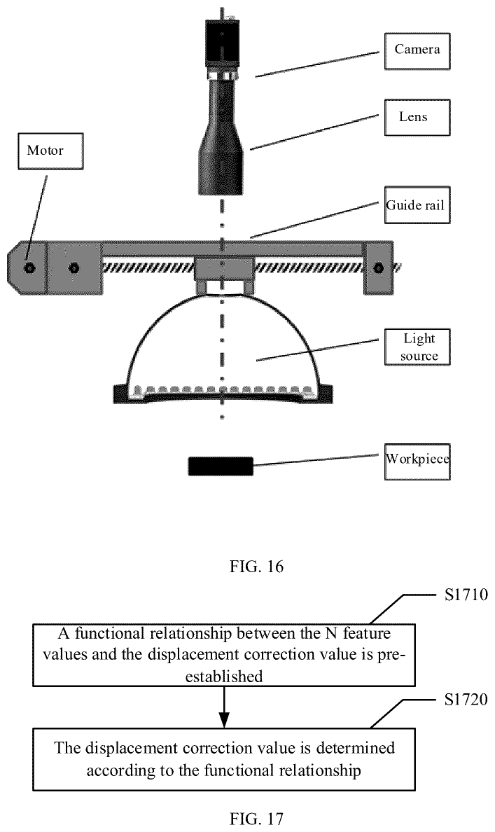

FIG. 16 schematically shows a structural diagram of an apparatus of acquiring an image according to some embodiments of the present disclosure. However, the present disclosure is not limited to this.

In some embodiments, an apparatus of acquiring an image is provided to perform the method of acquiring the image of some embodiments of the present disclosure. The apparatus of acquiring the image may include a shadowless light source, an image acquisition device, an image processing device, and a movable mechanism.

The shadowless light source is located on a side of the target object. The image acquisition device is used to capture an image of the target object with lighting of the shadowless light source. The image contains a first region of the target object and a second region of the target object, and a surface height of the first region is different from that of the second region. The image processing device is used to calculate N feature values of the image according to a relative positional relationship between the first region and the second region, where N is greater than or equal to 1. When at least one of the N feature values does not meet a predetermined condition, a displacement correction value of the shadowless light source is determined according to the at least one feature value. The movable mechanism is connected to the shadowless light source to adjust the position of the shadowless light source according to the displacement correction value, so that the image acquisition device may re-capture an image and the image processing device may re-calculate N feature values until the N feature values meet the predetermined condition.

Referring to FIG. 16, the light source may include a bowl-shaped light source. For example, the target object (i.e., workpiece) is a display device, which is placed on a stage (not shown), and a side where the plane region 110 and the bending region 120 of the chip-on-film 100 are located faces upwards. The bowl-shaped light source is located above the display device to achieve a dark field light environment. The image acquisition device may be placed above the bowl-shaped light source to capture an image of the target object in a vertical direction. The captured image may be digitized and transmitted to the image processing device, such as a computer, to calculate the feature value and the displacement correction value.

For example, the image acquisition device mainly includes a camera and a lens. The camera may be an industrial array camera, and the lens may be an industrial telecentric lens. The moving device may include a motor and a guide rail. A slider on the guide rail is connected to the bowl-shaped light source, and may drive the bowl-shaped light source to perform a position adjustment and achieve an optimal lighting angle, so that the image of the plane region 110 and the image of the bending region 120 have close feature values, and a detection interference may be reduced. The movable device may be a screw motor/UVW alignment device to drive a quantitative movement of the light source. If the shadowless light source only needs to move in one axial direction, the motor and the guide rail may be used to adjust the position of the shadowless light source. If a position correction between multiple axial directions needs to be performed, an alignment device such as a UVW alignment platform may be used.

Taking the image acquisition of the PAD detection region 500 of the OLED product shown in FIG. 5 as an example, because it is difficult to determine the optimal lighting position of the shadowless light source for the PAD detection region 500, various cases as shown in FIG. 7 may occur in the image acquisition, which causes interference such as shadow region/bright-dark intersection line, so that the image quality is seriously affected, and the efficiency and application range of automated image acquisition are affected. In addition, different products may have differences in the bending radius of the chip-on-film 100 and the flatness of the chip-on-film 100 adhered after bending. When acquiring images of different products, the lighting position for a previous product does not apply to a next product, so that the image quality may not meet requirements.

The apparatus of acquiring the image according to embodiments of the present disclosure may automatically adjust the position of the light source based on the feature values of the first region and the feature values of the second region, and ultimately make the feature values of the first region close to the feature values of the second region in the acquired image, thereby eliminating interference and balancing the image qualities of different regions.

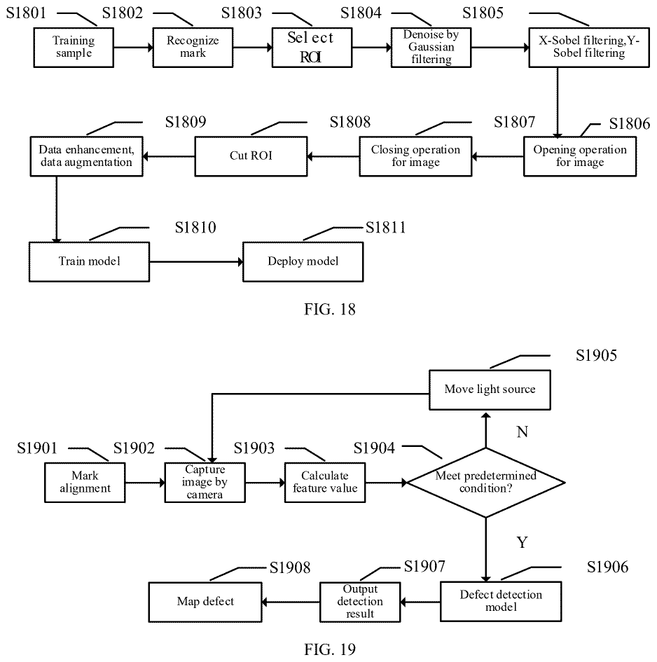

FIG. 17 schematically shows a flowchart of a method of detecting a defect according to some embodiments of the present disclosure. FIG. 18 schematically shows a flowchart of training and deploying a defect detection model according to some embodiments of the present disclosure.

As shown in FIG. 17, the method of detecting the defect in such embodiments includes operation S1710 to operation S1720.

In operation S1710, an image of a target object is obtained according to the method of acquiring the image in some embodiments of the present disclosure.

In operation S1720, the image is processed using a defect detection model to obtain a defect detection result output by the defect detection model.

For example, a defect detection model may be constructed and trained based on a deep learning algorithm. Referring to FIG. 18, a training sample is obtained, which is a defect sample of the same type of target object for detection (operation S1801), a mark point in the training sample is captured (operation S1802), a region of interest is selected based on the mark point (operation S1803), a Gaussian filtering is performed on the image of the region of interest to denoise the image (operation S1804), an X-Sobel filtering and a Y-Sobel filtering are performed to eliminate noise and sharpen edges (operation S1805). An opening operation is performed on the image to remove an edge information in the region of interest (operation S1806). Then a closing operation is performed on the image to eliminate noise (operation S1807). The preprocessed image of the region of interest is cut to have such a size that the model may process (operation S1808). Considering a limited amount of samples or an uneven distribution of defects, a data enhancement and an Mosaic and Mixup data augmentation are performed (operation S1809), and the samples are input into the defect detection model for training (operation S1810). For example, the data is firstly propagated forward to calculate a loss function value according to a defect detection result and a sample defect label, and then propagated backward to update a model parameter until the loss function value is less than a particular value. The trained defect detection model is deployed to a production environment through TensorRT (operation S1811).

Referring to FIG. 5, the folded chip-on-film 100 mainly includes the fitting plane region 110 and the bending region 120, which region is prone to defects such as crack, scratch and bubble. Taking crack as an example, a crack passing through the wire in the PAD detection region 500 may cause a short circuit and result in abnormal screen lighting. A crack not passing through the wire may also gradually develop and expand to the wire region and then cause abnormal lighting. A defect detection is generally performed using AOI (Automated Optical Inspection) and then using a corresponding visual algorithm. However, a missed detection often occurs as the quality of the acquired image does not meet requirements.

In some embodiments, referring to FIG. 16, as a wire interface and a main defect width (such as crack width) in the PAD detection region 500 are mostly in a range from 1 μm to 5 μm, a camera and lens combination accuracy may be preferably in a range from 0.2 μm/pixel to 1.5 μm/pixel, which may present defects well.

In some embodiments, the first threshold of the shadow width may be determined according to the main defect width. For example, the first threshold is less than the main defect width, so as to avoid a case that the shadow region is too large and covers the defect. The second threshold of the brightness difference may be determined according to an average brightness difference between a defect and a surrounding region. For example, the second threshold is less than an average zero degree difference, so that a significance of the defect may be improved, and a missed detection may be avoided.

It may be understood that in the present disclosure, the target object for defect detection is not limited to a display device, but may also be other irregular workpieces or other products, such as a semiconductor substrate, an electronic part, a rubber part, or a mechanical part.

According to embodiments of the present disclosures, it is possible to obtain an image that meets requirements, improve the defect detection efficiency and accuracy, and avoid missed detections.

FIG. 19 schematically shows a flowchart of performing an image acquisition and a defect detection according to some embodiments of the present disclosure.

As shown in FIG. 19, the image acquisition and the defect detection in such embodiments may include operation S1901 to operation S1908. A display device is illustrated by way of example in the following description.

In operation S1901, a mark point alignment is performed to capture a metal cross or T-shaped mark point on the chip-on-film 100 in a field of view of a camera so that a current coordinate of the mark point coincides with a predetermined coordinate.

In operation S1902, the camera captures an image of the PAD detection region 500 as shown in FIG. 5.

In operation S1903, a feature value such as at least one of a shadow width, a shadow area or a brightness difference is calculated.

In operation S1904, it is determined whether each feature value meets a predetermined condition. If so, operation S1906 is executed; if not, operation S1905 is executed.

In operation S1905, the light source is moved to adjust the position of the shadowless light source, and operation S1902 is re-executed.

In operation S1906, the image is input into a defect detection model.

In some embodiments, before processing the image using the defect detection model, the method further includes preprocessing the image. With reference to operation S1802 to operation S1808, at least part of the preprocessing is as follows.

Firstly, a position of a reference point in at least part of the pad region in the image, such as the metal cross or T-shaped mark point on the chip-on-film 100 in the image, is determined.

Then, a fourth region of interest including a wire in at least part of the pad region is determined according to the position of the reference point. A size of the ROI is set according to a size of a region where the metal wire is located, and then an image of the fourth region of interest is cut from the original image according to the center point of the mark point to generate the image of the fourth region of interest. A noise reduction may be performed on the image of the fourth region of interest. For example, the image may be preprocessed by Gaussian filtering, X-sobel filtering, and Y-sobel filtering to eliminate noise and sharpen edges.

Then, the image of the fourth region of interest is processed to extract a boundary of a wire, and the defect detection model is configured to perform a defect detection on the wire. For example, for the image of the fourth region of interest, a binarization is performed with a set threshold, then an expansion and corrosion is performed to eliminate small bright spots in the metal wire region and smooth the boundary of metal wires to break an adhesion between adjacent wires. Then, a corrosion and expansion is performed on the image of the fourth region of interest to fill small dark spots and broken contour lines in the metal wires, and smooth the metal wire boundary again without changing the metal wire area.

Finally, the image of the fourth region of interest is cut and input into the defect detection model. The image of fourth region of interest is cut into images with a specific size, such as 640*640, 1024*1024, etc., for processing of the defect detection model.

In operation S1907, a detection result output by the defect detection model is obtained.

In operation S1908, the defect is mapped. A coordinate of the defect in the detection result is mapped back to the acquired original image, and the detect is marked.

According to embodiments of the present disclosure, the correction value of the light source position is calculated by calculating the feature value of the image, and then the light source position is corrected through the corresponding automated displacement mechanism to achieve the optimal image acquisition effect, thereby achieving the automated image acquisition. Furthermore, an efficient detection of defect may be achieved according to the acquired image by using a processing method of machine vision+deep learning.

It should be noted that some steps of the above-mentioned method may be executed separately or in combination, and may be executed in parallel or sequentially, which are not limited to the specific operation sequence shown in the drawings.

It should also be noted that in some embodiments, the display device provided in embodiments of the present disclosure may specifically be a liquid crystal display device, or include an organic light emitting diode (OLED) display panel 200, or include a quantum dot light emitting diode (QLED) display panel 200, which is not limited here.

In some embodiments, the display device provided in embodiments of the present disclosure may be a 3D display device or other display devices, which may be any product or component having a display function, such as a mobile phone, a tablet computer, a television, a display, a laptop computer, a digital photo frame, a navigator, a smart watch, a fitness wristband, a personal digital assistant, etc. Optionally, the above-mentioned display device provided in embodiments of the present disclosure includes but is not limited to: a radio frequency unit, a network module, an audio output&input unit, a sensor, a display unit, a user input unit, an interface unit, a control chip, and other components. Optionally, the control chip may be a central processing unit, a digital signal processor, a system chip (SoC), etc. For example, the control chip may also include a memory, a power module, etc., and may achieve power supply and signal input/output functions through separately provided wires, signal lines, etc. For example, the control chip may also include a hardware circuit and a computer executable code. Furthermore, it may be understood by those skilled in the art that the above-mentioned structure does not constitute a limitation on the display device provided in embodiments of the present disclosures. In other words, the display device provided in embodiments of the present disclosures may include more or fewer components, or a combination of some components, or have a different component arrangement.

Here, the terms “substantially”, “about”, “approximately” and other similar terms are used as terms of approximation rather than terms of degree, and they are intended to explain an inherent deviation of a measured or calculated value that will be recognized by those ordinary skilled in the art. Taking into account a process fluctuation, a measurement problem, an error related to a measurement of a specific quantity (that is, a limitation of a measurement system) and other factors, the terms “about” or “approximately” used herein includes a stated value and means that a specific value determined by those ordinary skilled in the art is within an acceptable range of deviation. For example, “about” may mean being within one or more standard deviations, or within ±10% or ±5% of the stated value.

Although some embodiments according to the general inventive concept of the present disclosure have been illustrated and explained, it may be understood by those skilled in the art that changes may be made to these embodiments without departing from the principles and spirit of the general inventive concept of the present disclosure, and the scope of the present disclosure is defined by the claims and their equivalents.

1. A method of acquiring an image, comprising:
capturing an image of a target object with lighting of a shadowless light source, wherein the image of the target object contains a first region of the target object and a second region of the target object, and a surface height of the first region is different from a surface height of the second region;
calculating N feature values of the image according to a relative positional relationship between the first region and the second region, where N is an integer greater than or equal to 1;
determining a displacement correction value of the shadowless light source according to the N feature values, in response to the N feature values not meeting a predetermined condition; and
adjusting a position of the shadowless light source according to the displacement correction value to re-capture the image and re-calculate the N feature values until the N feature values meet the predetermined condition.

2. The method according to claim 1, further comprising:
pre-establishing a functional relationship between the N feature values and the displacement correction value;
wherein the determining a displacement correction value of the shadowless light source comprises:
determining the displacement correction value according to the functional relationship.

3. The method according to claim 2, wherein the target object is any type of object in M types of objects, and the M types of objects are different in term of the relative positional relationship between the first region and the second region, where M is greater than or equal to 2;
wherein the pre-establishing a functional relationship between the N feature values and the displacement correction value comprises:
pre-establishing M functional relationships respectively corresponding to the M types of objects.

4. The method according to claim 3, further comprising, before determining the displacement correction value according to the functional relationship:
determining a type of the target object; and
determining the functional relationship corresponding to the type of the target object.

5. The method according to claim 1, wherein the target object has a first side facing the shadowless light source, the first region and the second region are located on the first side, the surface height comprises a distance between a region surface and a second side of the target object, and the second side is opposite to the first side; and
wherein the surface height of the first region being different from the surface height of the second region comprises: a first distance between at least part of a surface of the first region and the second side is different from a second distance between at least part of a surface of the second region and the second side.

6. The method according to claim 1, wherein the N feature values comprise at least one selected from:
a shadow width, comprising a maximum length of a shadow region in a first direction in the image;
a shadow area, comprising an area of the shadow region; or
a brightness difference, obtained according to a difference between an average grayscale value of at least part of the first region in the image and an average grayscale value of at least part of the second region in the image.

7. The method according to claim 6, wherein the first region is connected to the second region, and the calculating N feature values of the image comprises:
determining a position of a reference point on the target object in the image;
determining a first region of interest in the image according to the position of the reference point, wherein the first region of interest comprises a connecting portion between the first region and the second region; and
calculating the shadow width in the first region of interest.

8. The method according to claim 7, wherein the calculating the shadow width in the first region of interest comprises:
calculating an average grayscale value in the first region of interest;
multiplying the average grayscale value in the first region of interest by a binarization coefficient to obtain a binarization threshold;
binarizing the first region of interest according to the binarization threshold; and
determining the shadow region and the maximum length of the shadow region in the first direction according to a result of the binarizing, wherein an average grayscale value of the shadow region is greater than an average grayscale value of a remaining region in the first region of interest.

9. The method according to claim 6, wherein the predetermined condition comprises a first threshold of the shadow width, and the determining a displacement correction value of the shadowless light source according to the N feature values comprises:
determining the displacement correction value according to a pre-established functional relationship between the shadow width and the displacement correction value, in response to the shadow width being greater than the first threshold.

10. The method according to claim 9, wherein
the pre-established functional relationship between the shadow width and the displacement correction value is obtained by: before acquiring the image;
adjusting the position of the shadowless light source S times in response to the shadow width being greater than or less than the first threshold, where S is greater than or equal to 2;
recording each adjusted position of the shadowless light source and the shadow width corresponding to each adjusted position; and
fitting S adjusted positions of the shadowless light source and the shadow widths corresponding to the adjusted positions, so as to obtain the functional relationship between the shadow width and the displacement correction value.

11. (canceled)

12. The method according to claim 6, wherein the calculating N feature values of the image comprises:
determining a position of a reference point on the target object in the image;
determining a second region of interest in the first region and a third region of interest in the second region in the image according to the position of the reference point; and
calculating a brightness difference between the second region of interest and the third region of interest.

13. The method according to claim 12, wherein the calculating a brightness difference between the second region of interest and the third region of interest comprises:
determining a first brightness-sensitive region in the second region of interest and a second brightness-sensitive region in the third region of interest, wherein each of the first brightness-sensitive region and the second brightness-sensitive region has a greater reflectivity than a non-brightness-sensitive region; and
calculating a brightness difference between the first brightness-sensitive region and the second brightness-sensitive region.

14. The method according to claim 13, wherein the predetermined condition comprises a second threshold of the brightness difference, and the determining a displacement correction value of the shadowless light source according to the N feature values comprises:
determining the displacement correction value according to a pre-established functional relationship between the brightness difference and the displacement correction value, in response to the brightness difference being greater than the second threshold;
wherein the pre-established functional relationship between the brightness difference and the displacement correction value is obtained by, before acquiring the image:
adjusting the position of the shadowless light source K times in response to the brightness difference being greater than or less than the second threshold, where K is greater than or equal to 2;
recording each adjusted position of the shadowless light source and the brightness value corresponding to each adjusted position; and
fitting K adjusted positions of the shadowless light source and the brightness values corresponding to the adjusted positions, so as to obtain the functional relationship between the brightness value and the displacement correction value.

15. (canceled)

16. The method according to claim 1, further comprising, before capturing the image of the target object:
obtaining a current coordinate of a reference point on the target object, wherein the reference point is used to determine a position of at least one of the first region and the second region; and
moving the target object so that the current coordinate coincides with a predetermined coordinate, in response to the current coordinate being inconsistent with the predetermined coordinate.

17. The method according to claim 1, wherein:
the first region has a flat surface, the second region has an arc-shaped surface, and at least part of the arc-shaped surface is higher than the flat surface;
the target object comprises a display device, and the capturing an image of a target object comprises: capturing an image of at least part of a pad region of the display device, wherein the at least part of the pad region comprises a plane region of a chip-on-film and a bending region of the chip-on-film, the first region comprises the plane region, and the second region comprises the bending region; or
the shadowless light source comprises a bowl-shaped light source.

18-19. (canceled)

20. An apparatus of acquiring an image, for performing the method of acquiring the image of claim 1, the apparatus comprising:
a shadowless light source located on a side of a target object;
an image acquisition device configured to capture an image of the target object with lighting of the shadowless light source, wherein the image contains a first region of the target object and a second region of the target object, and a surface height of the first region is different from a surface height of the second region;
an image processing device configured to: calculate N feature values of the image according to a relative positional relationship between the first region and the second region, where N is an integer greater than or equal to 1; and determine a displacement correction value of the shadowless light source according to at least one of the N feature values, in response to the at least one feature value not meeting a predetermined condition; and
a moving mechanism connected to the shadowless light source, wherein the moving mechanism is configured to adjust a position of the shadowless light source according to the displacement correction value, so that the image acquisition device re-captures the image and the image processing device re-calculates the N feature values, until the N feature values meet the predetermined condition.

21. A method of detecting a defect, comprising:
obtaining an image of a target object according to the method of acquiring the image of claim 1; and
processing the image using a defect detection model to obtain a defect detection result output by the defect detection model.

22. The method according to claim 21, wherein the target object comprises a display device, the image comprises at least part of a pad region of the display device, and the at least part of the pad region comprises a plane region of a chip-on-film and a bending region of the chip-on-film, the method further comprising pre-processing the image before processing the image using the defect detection mode, wherein pre-processing the image comprises:
determining a position of a reference point on the at least part of the pad region in the image;
determining a fourth region of interest according to the position of the reference point, wherein the fourth region of interest comprises a wire region on the at least part of the pad region; and
processing the fourth region of interest to extract a boundary of a wire, wherein the defect detection model is configured to perform a defect detection on the wire.

23. An electronic device, comprising:
at least one processor; and
a memory communicatively connected to the at least one processor, wherein the memory stores instructions executable by the at least one processor, and the instructions, when executed by the at least one processor, cause the at least one processor to implement the method of claim 1.

24. A non-transitory computer-readable storage medium having computer instructions therein, wherein the computer instructions are configured to cause a computer to implement the method of claim 1.
